(19) United States
(12) Patent Application Publication
(10) Pub. No.: US 2013/0070389 A1
(43) Pub. Date: Mar. 21, 2013

(54) ELECTRODE FOR ENERGY STORAGE AND METHOD FOR MANUFACTURING THE SAME

(71) Applicants: Hak Kwan KIM, Seoul (KR); Chang Ryul Jung, Seoul (KR); Seung Min Kim, Seoul (KR); Bae Kyun Kim, Gyeonggi-do (KR)

(72) Inventors: Hak Kwan KIM, Seoul (KR); Chang Ryul Jung, Seoul (KR); Seung Min Kim, Seoul (KR); Bae Kyun Kim, Gyeonggi-do (KR)

(73) Assignee: SAMSUNG ELECTRO-MECHANICS CO., LTD.

(21) Appl. No.: 13/570,780

(22) Filed: Aug. 9, 2012

(30) Foreign Application Priority Data
Sep. 19, 2011 (KR) 10-2011-0094139

(51) Int. Cl. H01G 9/058; B82Y 99/00

(52) U.S. Cl. 361/502; 427/58; 216/18; 977/948

(57) ABSTRACT

The present invention relates to an electrode for an energy storage and a method for manufacturing the same and provides a useful effect of improving resistance characteristics of an electrode for an energy storage by forming a trench of predetermined dimensions on a surface of a current collector, forming a conductive layer, which includes a conductive agent as much as possible, on the surface of the current collector, and forming an electrode layer including an electrode active material, a conductive agent, and a binder on the conductive layer.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0094139, entitled filed Sep. 19, 2011, which is hereby incorporated by reference in its entirety into this application.

### BACKGROUND OF THE INVENTION

1. Field of the Invention

The present invention relates to an electrode for an energy storage and a method for manufacturing the same.

2. Description of the Related Art

Electrochemical capacitors can be classified roughly into a pseudocapacitor and an electric double layer capacitor (EDLC).

The pseudocapacitor uses a metal oxide as an electrode active material, and development of capacitors using a metal oxide has been continuously made for the past 20 years.

Meanwhile, most studies of the pseudocapacitor use a ruthenium oxide, an iridium oxide, a tantalum oxide, and a vanadium oxide.

The pseudocapacitor has a disadvantage that utilization of the electrode active material is reduced due to non-uniformity of potential distribution of a metal oxide electrode.

In case of the EDLC, currently, a porous carbon material with high electrical conductivity, high thermal conductivity, low density, suitable corrosion resistance, low coefficient of thermal expansion, and high purity is used as an electrode active material. However, in order to improve performance of the capacitor, many studies have been made on preparation of a new electrode active material, surface modification of the electrode active material, performance improvement of a separator and an electrolyte, and performance improvement of an organic solvent electrolyte for increasing utilization and cycle life of the electrode active material and improving high rate charging and discharging characteristics.

In case of a currently studied capacitor, a current collector made of an aluminum or titanium sheet or an expanded aluminum or titanium sheet is mainly used as current collectors of both electrodes and in addition, various types of current collectors such as a punched aluminum or titanium sheet are used.

However, these current collectors have relatively high contact resistance with an electrode active material due to an oxide layer naturally formed on a surface thereof. Due to this, there are limits to charging and discharging characteristics and cycle life.

Since there is an increasing demand of industry for high voltage and high rate charging and discharging characteristics, it is necessary to improve these characteristics.

FIG. 1 is a view schematically illustrating a typical electrode structure of the prior art.

Referring to FIG. 1, generally, a current collector 20 is implemented with an aluminum foil with a thickness of 20 to 30 μm, and at this time, a surface of the aluminum foil is etched with acid to form a trench with a thickness of 2 to 5 μm.

When the surface of the current collector 20 is treated like this, since a surface area of the current collector 20 is increased, it causes an increase in effective contact area between the current collector 20 and an electrode active material 10 and a reduction in contact resistance between the current collector 20 and the electrode active material 10.

However, actually, when magnifying and looking into a boundary between an electrode and the current collector through an electron microscope, it is possible to check that the electrode active material is not in complete contact with the current collector 20 along the trench and there is an empty space 22.

That is, although it looks to the naked eye that the current collector and the electrode active material are well bonded to each other, actually, there are many non-contact portions and thus contact resistance is increased.

A cause of this non-contact region is that an average particle diameter of activated carbon powder, an electrode active material mainly used at this time, is 5 to 10 μm, which is greater than an average width of the trench, that is, about 1 to 2 μm.

As current and voltage applied to the current collector are increased, the contact resistance increased due to the non-contact region causes greater performance degradation.

Meanwhile, Patent Document 1 discloses a technology that an electrical conductive layer is provided between a capacitance enhancing layer and a current collector to overcome this problem.

The electrical conductive layer used in the Patent Document 1 should include a binder of more than 10 wt % to satisfy adhesion with the current collector. It is because the current collector and the electrical conductive layer are easily separated from each other and thus reliability is reduced when the binder content is reduced.

However, when the binder content is high like the technology disclosed in the Patent Document 1, the conductive agent content should be reduced. That is, since the conductive agent content in the electrical conductive layer in accordance with the Patent Document 1 can not be more than 90 wt %, there is a limit in reducing resistance.

### RELATED PRIOR ART DOCUMENT

Patent Document 1: Korean Patent Laid-open Publication No. 10-2004-0101643

### SUMMARY OF THE INVENTION

The present invention has been invented in order to overcome the above-described problems and it is, therefore, an object of the present invention to provide an electrode for an energy storage capable of maximizing conductivity of a conductive layer provided between a current collector and an electrode layer and a method for manufacturing the same.

In accordance with one aspect of the present invention to achieve the object, there is provided an electrode for an energy storage including: a current collector having a plurality of trenches formed on a surface thereof; a conductive layer formed by adhering a material including a binder and a conductive agent to the surface of the current collector; and an electrode layer formed by adhering a material including an electrode active material, a conductive agent, and a binder to a surface of the conductive layer, wherein a ratio of horizontal cross section to depth of the trench is 1:3.

At this time, an average horizontal cross section of the trench may be 0.5 to 1 μm, and a particle diameter of the conductive agent and the binder may be 50 to 300 nm.

Further, a weight ratio of the conductive agent in the conductive layer may exceed 90 wt %.

Further, the conductive agent may be at least one material or a mixture of at least two materials selected from graphite, cokes, activated carbon, carbon black, carbon nanotube (CNT), and graphene.

Further, the binder may be at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

In accordance with another aspect of the present invention to achieve the object, there is provided a method for manufacturing an electrode for an energy storage including: forming a plurality of trenches on a surface of a current collector: applying conductive slurry including a conductive agent and a binder on the surface of the current collector; forming a conductive layer by pressing the conductive slurry in the direction of a surface adhered to the current collector; and forming an electrode layer by applying electrode slurry including an electrode active material, a conductive agent, and a binder on a surface of the conductive layer, wherein a ratio of horizontal cross section to depth of the trench is 1:3.

At this time, the step of forming the trench may perform treatment for several seconds to tens of minutes using at least one material selected from the group consisting of hydrochloric acid, phosphoric acid, fluosilicic acid, and sulfuric acid.

Further, the step of forming the trench may perform chemical etching at 80° C. for 10 minutes using a mixture of 1.0 M hydrochloric acid (HCl) and 0.1 M phosphoric acid (H₃PO₄).

Further, the step of forming the trench may include the steps of performing ultrasonic cleaning for each 20 minutes sequentially using acetone and ethyl alcohol; performing pretreatment for 60 seconds using fluosilicic acid; and performing chemical etching for 10 minutes using a mixture of 1.0 M hydrochloric acid (HCl) and 0.1 M phosphoric acid (H₃PO₄).

Further, an average horizontal cross section of the trench formed in the step of forming the trench may be 0.5 to 1.0 μm, and a particle diameter of the conductive agent and the binder included in the conductive slurry may be 50 to 300 nm.

At this time, the step of forming the conductive layer may be performed by a hot roll press method.

Further, a weight ratio of the conductive agent in the conductive slurry may exceed 90 wt %.

Further, the conductive agent may be at least one material or a mixture of at least two materials selected from graphite, cokes, activated carbon, carbon black, carbon nanotube (CNT), and graphene.

Further, the binder may be at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view schematically illustrating a typical electrode structure of the prior art;

FIG. 2 is a cross-sectional view schematically illustrating an electrode structure in accordance with an embodiment of the present invention;

FIG. 3 is a view for explaining conditions of a trench in accordance with an embodiment of the present invention; and

FIG. 4 is a graph showing measurement results of resistance characteristics of an electrode in accordance with an embodiment of the present invention and resistance characteristics of an existing electrode.

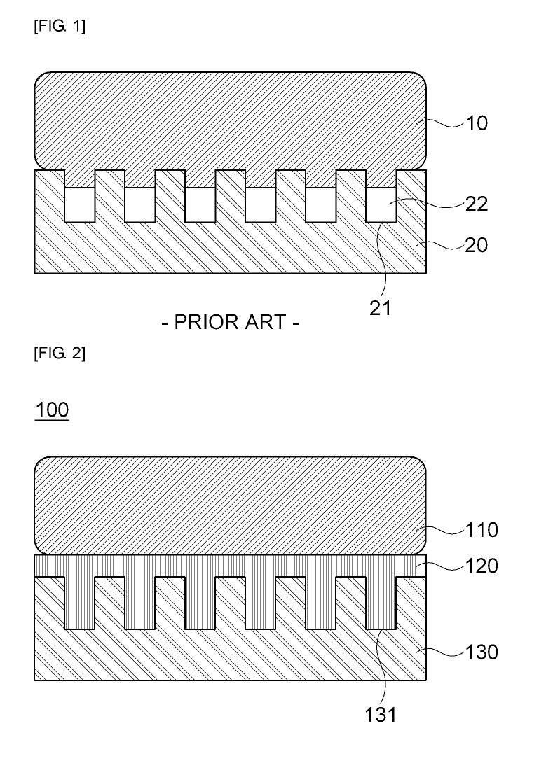

### DETAILED DESCRIPTION OF THE PREFERABLE EMBODIMENT

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. Further, terms “comprises” and/or “comprising” used herein specify the existence of described components, steps, operations, and/or elements, but do not preclude the existence or addition of one or more other components, steps, operations, and/or elements.

Hereinafter, configuration and operational effect of the present invention will be described in detail with reference to the accompanying drawings.

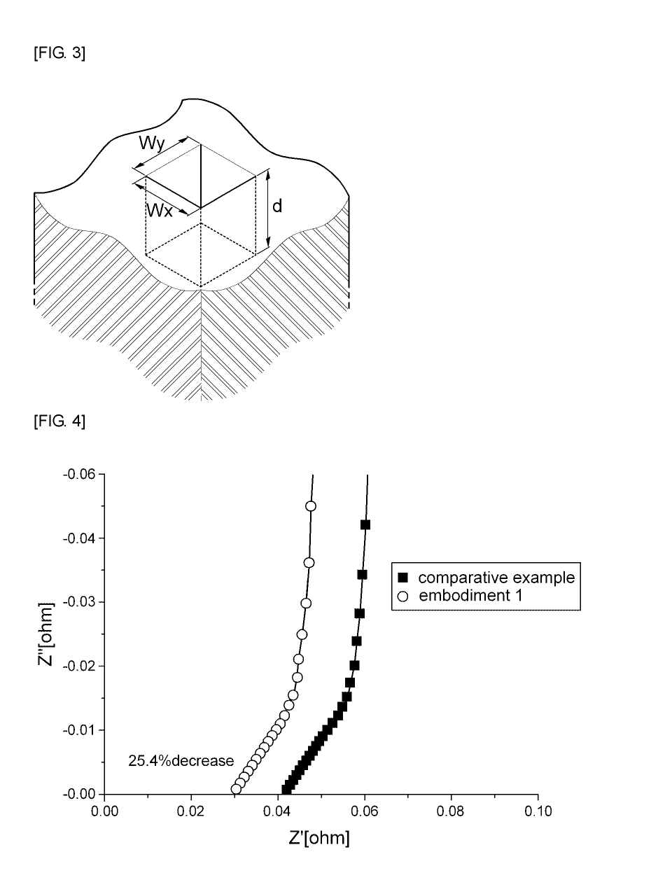

FIG. 2 is a cross-sectional view schematically illustrating an electrode structure in accordance with an embodiment of the present invention, and FIG. 3 is a view for explaining conditions of a trench 131 in accordance with an embodiment of the present invention.

Referring to FIGS. 2 and 3, an electrode for an energy storage in accordance with an embodiment of the present invention may include a current collector 130 having trenches 131, a conductive layer 120, and an electrode layer 110.

The current collector 130 may be implemented with an aluminum or titanium sheet or an expanded aluminum or titanium sheet.

A plurality of trenches 131 are formed on a surface of the current collector 130.

The trench 131 performs a role of improving adhesion between the current collector 130 and the conductive layer 120 by increasing a specific surface area of the current collector 130.

At this time, it is preferred that the trench 131 is formed at a ratio of horizontal cross section to depth of 1:3.

When the depth is too large compared to the horizontal cross section, there are problems with uniformity and density in the overall formation of the trench 131 and disconnection of the current collector 130 due to a reduction in strength of the current collector 130 in a process of manufacturing a cell of an electrochemical capacitor. Further, there is a limit in increasing an actual effective contact area with the conductive layer 120.

On the contrary, when the depth is too small compared to the horizontal cross section, there is a problem that it is difficult to obtain an effect due to an increase in the contact area compared to an existing current collector.

The conductive layer 120 may include a conductive agent with high electrical conductivity.

At this time, the conductive agent may be at least one material selected from graphite, cokes, activated carbon, carbon black, carbon nanotube (CNT), and graphene.

Meanwhile, the conductive layer 120 includes a binder for adhesion between the conductive agents, between the conductive layer 120 and the current collector 130, and between the conductive layer 120 and the electrode layer 110.

The binder may be at least one material selected from fluorine resins such as polytetrafluoroethylene (PTFE) and polyvinylidenfluoride (PVDF); thermoplastic resins such as polyimide, polyamideimide, polyethylene (PE), and polypropylene (PP); and cellulose resins such as carboxymethyl cellulose (CMC); rubber resins such as styrene-butadiene rubber (SBR); and mixtures thereof.

Meanwhile, it is preferred that an average horizontal cross section of the trench 131 is 0.5 to 1 μm and a particle diameter of the conductive agent and the binder is 50 to 300 nm.

The reason is because the conductive agent should be filled in the trench 131 without empty space. If the particle diameter is larger than the cross section of the trench 131, since the empty space inside the trench is not completely filled, resistance is increased.

Further, the conductive agent constituting the conductive layer 120 is densely introduced inside the trench 131, the adhesion between the conductive layer 120 and the current collector 130 is increased.

Accordingly, although the binder content of the conductive layer 120 is less than 10 wt %, the adhesion between the conductive layer 120 and the current collector 130 is sufficiently secured, and since the binder content is reduced, electrical conductivity is also improved than before.

Meanwhile, a method for manufacturing an electrode for an energy storage in accordance with an embodiment of the present invention may include the steps of forming a plurality of trenches 131 on a surface of a current collector 130; applying conductive slurry including a conductive agent and a binder on the surface of the current collector 130; forming a conductive layer 120 by pressing the conductive slurry in the direction of a surface adhered to the current collector 130; and forming an electrode layer 110 by applying electrode slurry including an electrode active material, a conductive agent, and a binder on a surface of the conductive layer 120.

First, the plurality of trenches 131 are formed by treating the surface of the current collector 130.

At this time, the surface of the current collector 130 is treated for several seconds to tens of minutes with at least one material selected from the group consisting of hydrochloric acid, phosphoric acid, fluosilicic acid, and sulfuric acid.

As a result of this treatment, the trench 131 is formed at a ratio of horizontal cross section to depth of 1:3.

Further, an average horizontal cross section of the trench 131 is 0.5 to 1 μm.

Next, the conductive slurry including a conductive agent and a binder is applied on the surface of the current collector 130.

At this time, it is preferable to prepare the conductive slurry so that the binder content exceeds 90 wt % to maximize resistance characteristics.

Further, as described above, since the average horizontal cross section of the trench 131 is 0.5 to 1 μm, in preparing the conductive slurry, it is preferable to use a conductive agent and a binder with a particle diameter of 50 to 300 nm. The reason is the same as described above and thus repeated description will be omitted.

Next, the conductive layer 120 is formed by pressing the conductive slurry in the direction of the surface adhered to the current collector 130.

At this time, a hot roll press method may be applied, and accordingly, the conductive slurry is deeply introduced into the trenches 131 so that the conductive layer 120 is formed. Due to this, contact resistance between the conductive layer 120 and the current collector 130 may be minimized.

FIG. 4 is a graph showing measurement results of resistance characteristics of an electrode in accordance with an embodiment of the present invention and resistance characteristics of an existing electrode.

### Embodiment 1: Manufacture of Metal Current Collector

After preparing a plain aluminum foil with a thickness of 25 μm, ultrasonic cleaning is performed for each 20 minutes sequentially using acetone and ethyl alcohol. Next, the cleaned aluminum foil is pretreated with fluosilicic acid (H₂SiF₆) at 45° C. for 60 seconds.

Next, chemical etching is performed at 80° C. for 10 minutes using a mixture of 1.0 M hydrochloric acid (HCl) and 0.1 M phosphoric acid (H₃PO₄).

Next, a current collector, on which an electrode material is to be applied, is prepared by performing ultrasonic cleaning for each 20 minutes sequentially using acetone and ethyl alcohol again.

### Comparative Example 1

An etched aluminum foil with a thickness of 20 μm is used as a metal current collector.

### Manufacture of Electrochemical Capacitor using Embodiment 1 and Comparative Example 1

1) Preparation of Electrode

Electrode active material slurry is prepared by mixing and stirring activated carbon (specific surface area 2150 m²/g) 85 g, super-p 18 g as a conductive agent, CMC 3.5 g, SBR 12.0 g, and PTFE 5.5 g as binders, and water 225 g.

The electrode active material slurry is applied on the metal current collector in accordance with the embodiment 1 and the comparative example 1 by a comma coater, temporarily dried, and cut to an electrode size of 50 mm×100 mm. A cross-sectional thickness of the electrode is 60 μm. Before assembly of a cell, the electrode is dried in a vacuum at 120° C. for 48 hours.

2) Preparation of Electrolyte

An electrolyte is prepared by dissolving a spiro salt in an acrylonitrile solvent so that concentration of the spiro salt is 1.3 mol/L.

3) Assembly of Capacitor Cell

The electrodes prepared in the step 1) are used as a cathode and an anode, immersed in the electrolyte with a separator (TF4035 from NKK, cellulose separator) interposed therebetween, and put in a laminate film case to be sealed so that a capacitor cell is assembled.

### Evaluation of Characteristics: Measurement of Resistance of Electrochemical Capacitor Cell

Resistance characteristics of each cell are measured at room temperature by an impedance spectroscopy, and measurement results are shown in FIG. 4.

Referring to FIG. 4, it is possible to check that the resistance characteristics are improved by more than 25% compared to a conventional case.

An electrode for an energy storage in accordance with an embodiment of the present invention configured as above provides a useful effect of improving resistance characteristics by minimizing use of a binder while preventing reduction of adhesion between a current collector, a conductive layer, and an electrode layer.

Further, a method for manufacturing an electrode for an energy storage in accordance with an embodiment of the present invention configured as above provides a useful effect of improving resistance characteristics of an electrode for an energy storage than before by optimizing dimensions of a trench and a particle diameter of a conductive agent and a binder to minimize the binder content.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. An electrode for an energy storage comprising:
a current collector having a plurality of trenches formed on a surface thereof;
a conductive layer formed by adhering a material including a binder and a conductive agent to the surface of the current collector; and
an electrode layer formed by adhering a material including an electrode active material, a conductive agent, and a binder to a surface of the conductive layer, wherein a ratio of horizontal cross section to depth of the trench is 1:3.

2. The electrode for an energy storage according to claim 1, wherein an average horizontal cross section of the trench is 0.5 to 1 μm, and a particle diameter of the conductive agent and the binder is 50 to 300 nm.

3. The electrode for an energy storage according to claim 1, wherein a weight ratio of the conductive agent in the conductive layer exceeds 90 wt %.

4. The electrode for an energy storage according to claim 1, wherein the conductive agent is at least one material or a mixture of at least two materials selected from graphite, cokes, activated carbon, carbon black, carbon nanotube (CNT), and graphene.

5. The electrode for an energy storage according to claim 1, wherein the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

6. The electrode for an energy storage according to claim 1, wherein the conductive agent is at least one material or a mixture of at least two materials selected from graphite, cokes, activated carbon, carbon black, carbon nanotube (CNT), and graphene, and the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

7. A method for manufacturing an electrode for an energy storage comprising:
forming a plurality of trenches on a surface of a current collector;
applying conductive slurry including a conductive agent and a binder on the surface of the current collector;
forming a conductive layer by pressing the conductive slurry in the direction of a surface adhered to the current collector; and
forming an electrode layer by applying electrode slurry including an electrode active material, a conductive agent, and a binder on a surface of the conductive layer, wherein the trench is formed at a ratio of horizontal cross section to depth of 1:3.

8. The method for manufacturing an electrode for an energy storage according to claim 7, wherein forming the trench performs treatment for several seconds to tens of minutes using at least one material selected from the group consisting of hydrochloric acid, phosphoric acid, fluosilicic acid, and sulfuric acid.

9. The method for manufacturing an electrode for an energy storage according to claim 7, wherein forming the trench performs chemical etching at 80° C. for 10 minutes using a mixture of 1.0 M hydrochloric acid (HCl) and 0.1 M phosphoric acid (H₃PO₄).

10. The method for manufacturing an electrode for an energy storage according to claim 7, wherein forming the trench comprises:
performing ultrasonic cleaning for each 20 minutes sequentially using acetone and ethyl alcohol;
performing pretreatment for 60 seconds using fluosilicic acid; and
performing chemical etching for 10 minutes using a mixture of 1.0 M hydrochloric acid (HCl) and 0.1 M phosphoric acid (H₃PO₄).

11. The method for manufacturing an electrode for an energy storage according to claim 7, wherein an average horizontal cross section of the trench formed in forming the trench is 0.5 to 1.0 μm, and a particle diameter of the conductive agent and the binder included in the conductive slurry is 50 to 300 nm.

12. The method for manufacturing an electrode for an energy storage according to claim 7, wherein forming the conductive layer is performed by applying a hot roll press method.

13. The method for manufacturing an electrode for an energy storage according to claim 7, wherein a weight ratio of the conductive agent in the conductive slurry exceeds 90 wt %.

14. The method for manufacturing an electrode for an energy storage according to claim 7, wherein the conductive agent is at least one material or a mixture of at least two materials selected from graphite, cokes, activated carbon, carbon black, carbon nanotube (CNT), and graphene.

15. The method for manufacturing an electrode for an energy storage according to claim 7, wherein the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

16. The method for manufacturing an electrode for an energy storage according to claim 7, wherein the conductive agent is at least one material or a mixture of at least two materials selected from graphite, cokes, activated carbon, carbon black, carbon nanotube (CNT), and graphene, and the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

17. An electrode for an energy storage comprising:
a current collector having a plurality of trenches, whose ratio of horizontal cross section to depth is 1:3, on a surface thereof;
a conductive layer formed by adhering a material including a binder of less than 10 wt % and a conductive agent of more than 90 wt % to the surface of the current collector; and
an electrode layer formed by adhering a material including an electrode active material, a conductive agent, and a binder to a surface of the conductive layer, wherein an average horizontal cross section of the trench is 0.5 to 1 μm, and a particle diameter of the conductive agent and the binder is 50 to 300 nm.

18. A method for manufacturing an electrode for an energy storage comprising:
forming a plurality of trenches at a ratio of horizontal cross section to depth of 1:3 by treating a current collector for several seconds to tens of minutes using at least one material selected from the group consisting of hydrochloric acid, phosphoric acid, fluosilicic acid, and sulfuric acid;
applying conductive slurry including a conductive agent of more than 90 wt % and a binder of less than 10 wt % on a surface of the current collector;
forming a conductive layer by pressing the conductive slurry in the direction of a surface adhered to the current collector; and
forming an electrode layer by applying electrode slurry including an electrode active material, a conductive agent, and a binder on a surface of the conductive layer.

19. The method for manufacturing an electrode for an energy storage according to claim 18, wherein an average horizontal cross section of the trench formed in forming the trench is 0.5 to 1 μm, and a particle diameter of the conductive agent and the binder included in the conductive slurry is 50 to 300 nm.

20. The method for manufacturing an electrode for an energy storage according to claim 18, wherein forming the trench comprises:
performing ultrasonic cleaning for each 20 minutes sequentially using acetone and ethyl alcohol;
performing pretreatment for 60 seconds using fluosilicic acid; and
performing chemical etching for 10 minutes using a mixture of 1.0 M hydrochloric acid (HCl) and 0.1 M phosphoric acid (H₃PO₄).
